(19) United States
(12) Patent Application Publication
(10) Pub. No.: US 2025/0049123 A1
(43) Pub. Date: Feb. 13, 2025

(54) A DEVICE

(71) Applicant: Nicoventures Trading Limited, London (GB)

(72) Inventors: Keri COX, Winston-Salem, NC (US); Billy CONNER, Winston-Salem, NC (US); Thaddeus JACKSON, Winston-Salem, NC (US); Patrick MOLONEY, London (GB); Walid Abi AOUN, London (GB); Catalin BALAN, London (GB); Juan Esteban Paz JAUREGUI, London (GB)

(21) Appl. No.: 18/719,755

(22) PCT Filed: Dec. 16, 2022
(86) PCT No.: PCT/GB2022/053281

§ 371 Date: Jun. 13, 2024

Related U.S. Application Data
(60) Provisional application No. 63/291,887, filed on Dec. 20, 2021.

(51) Int. Cl. A24F 40/46; A24F 40/20; A24F 40/465; A24F 40/485; A24F 40/51; H05B 6/10

(52) U.S. Cl. CPC A24F 40/46; A24F 40/20; A24F 40/465; A24F 40/485; A24F 40/51; H05B 6/108

(57) ABSTRACT

A non-combustible aerosol provision device (100) comprising an article receiving section (101); a heating apparatus (102), the heating apparatus (102) comprising a heating element (103), a plug (120) surrounding the heating element (103), and a power source (104) configured to heat the heating element (103), wherein the heating element (102) is located at least partially in the article receiving section (101) and the plug (120) is configured to be at least partially received within a heating apparatus receiving region in an article (1) placed in the article receiving section (101) during use.

### TECHNICAL FIELD

The present invention relates to an article for an aerosol provision device. More specifically, the present invention relates to an article comprising aerosol generating material for use with a non-combustible aerosol provision device.

### BACKGROUND

It is known to provide an aerosol provision system comprising an article comprising aerosol-generating material and a carbon tip. The carbon tip is lit by a user and generates heat to heat the aerosol-generating material and generate and aerosol. However, users may encounter difficulty lighting the carbon tip and excess heat from the tip when lit.

### SUMMARY

In one aspect of the present invention, there is provided a non-combustible aerosol provision device comprising: an article receiving section; a heating apparatus, the heating apparatus comprising a heating element, a plug surrounding the heating element, and a power source configured to heat the heating element, wherein the heating element is located at least partially in the article receiving section and the plug is configured to be at least partially received within a heating apparatus receiving region in an article placed in the article receiving section during use.

The plug may be configured to protect the heating element from contact with the article, during use.

The plug may extend substantially around the heating element. The plug may comprise a first portion in the form of a hollow cylinder configured to surround the heating element.

The plug may extend substantially over the heating element. The plug may extend substantially over the heating element such that the plug prevents direct contact between the heating element and an article when an article is received in the article receiving section.

The plug may comprise a second portion in the form of a dome configured to extend over the proximal end of the heating element.

The plug may comprise at least one aperture configured to provide a guide path to allow air flow from the device through the heating apparatus.

The at least one aperture may form at least one channel extending through the body of material forming the plug, the at least one channel being configured to allows fluid to pass from one side of the plug through the channels and into an article when an article is received in the article receiving section.

The plug may be configured to provide both conduction and convection heating.

The plug may comprise a centrally located aperture.

The plug may be configured to electrically insulate the heating element from the article, during use.

The plug may comprise a shoulder portion configured to receive a wrapper of an article.

The plug may be formed from a material which enables efficient heat transfer from the heating element to a conductor of an article. In some embodiments, the plug may be formed from a material which enables efficient heat transfer from the heating element to a foil wrapper of an article.

The plug may be configured to abut an inner surface of a heating apparatus receiving chamber of an article.

The plug may be formed from a material which protects the rest of the device from radiative heating.

The plug material may be inert and/or does not thermally decompose at temperatures of up to about 700 degrees Celsius to about 900 degrees Celsius.

The plug may be formed from one of ceramic, fibre glass, or anodised or enamelled metal.

The heating element may be spaced from the plug. The heating element may be in contact with the plug. The heating element may be embedded in the plug.

The heating element may be a resistive heating element, for example, a coil, mesh, ribbon, matrix, or an inductive heater.

The heating element may be configured to be a sensor for determining when there is airflow through the device.

The non-combustible aerosol provision device may further comprise a pressure sensor or an airflow sensor configured to allow the heating apparatus to be activated via puff activation.

According to another aspect of the present invention, there is provided a system for aerosolising an aerosolisable material comprising: an article comprising aerosol generating material; and a non-combustible aerosol provision device according to the claims.

According to another aspect of the present invention there is provided use of the non-combustible aerosol provision device according to the claims to generate aerosol from a consumable.

### BRIEF DESCRIPTION OF THE DRAWINGS

Embodiments will now be described, by way of example only, with reference to the accompanying drawings, in which:

FIG. 1 shows a schematic cross-sectional side view of an article of the present invention;

FIG. 2 shows a schematic cross-sectional side view of an article of the present invention;

FIG. 3 shows a schematic cross-sectional side view of an article of the present invention;

FIG. 4 shows a schematic cross-sectional side view of an article of the present invention;

FIG. 5 shows a schematic view of a non-combustible aerosol provision device of the present invention; and

FIG. 6 shows a schematic cross-sectional side view of a plug of the present invention.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be, or be produced by, an aerosol-generating material that may comprise one or more active constituents, one or more flavours, one or more aerosol-former materials, and/or one or more other functional materials. The substance to be delivered may be produced by the aerosol-generating material when heated. An aerosol generated by the aerosol-generating material may comprise the substance to be delivered.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise or be an aerosol-generating film. The aerosol-generating film may be formed by combining a binder, such as a gelling agent, with a solvent, such as water, an aerosol-former and one or more other components, such as active substances, to form a slurry and then heating the slurry to volatilise at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating film may comprise or be a sheet, which may optionally be shredded to form a shredded sheet.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

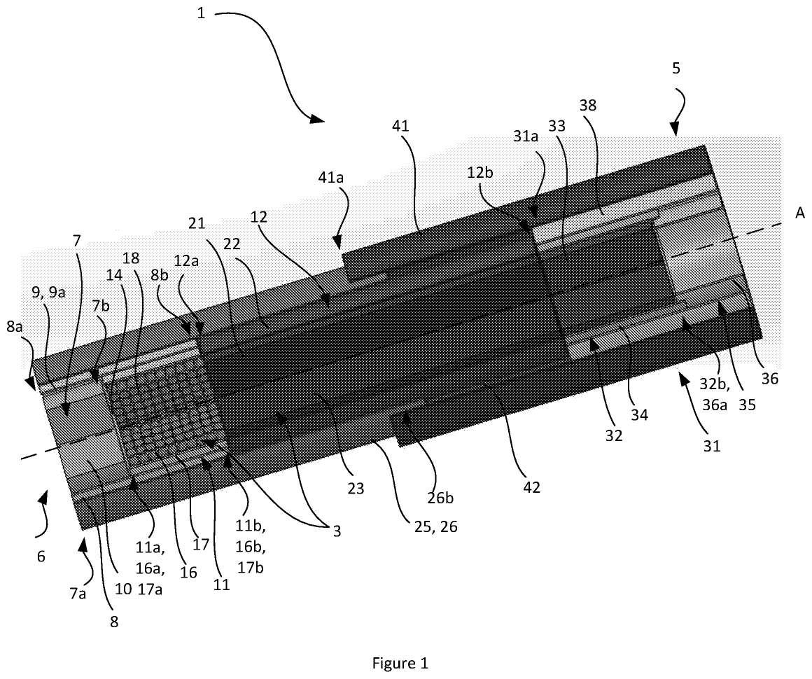

Referring to FIG. 1 to FIG. 3, an article 1 for use with a non-combustible aerosol provision device 100 is shown. The article 1 comprises at least one aerosol generating material 3. The article 1 further comprises a mouth end 5 and an opposing upstream end 6. The upstream end 6 comprises a heating apparatus receiving region 7. The heating apparatus receiving region 7 is located upstream of the aerosol generating material 3. The heating apparatus receiving region 7 is configured to receive a portion of a heating apparatus 102 of a non-combustible aerosol provision device 100 during use.

The article 1 further comprises a first wrapper 8 that circumscribes the heating apparatus receiving region 7 and at least a portion of at least one aerosol generating material 3. In the present embodiment, the article 1 comprises a first aerosol-generating material 11 and a second aerosol-generating material 12. The article 1 further comprises a conductor. The conductor is configured to transfer heat from the heating apparatus receiving region 7 to the aerosol generating material, during use. In the present embodiment, the conductor may be formed by the first wrapper 8. That is, the first wrapper 8 is configured to transfer heat from the heating apparatus receiving region 7 to at least one aerosol generating material 3, during use.

In the present embodiment, the article 1 is generally cylindrical in shape. That is, the article has a circular cross-section in a plane perpendicular to the longitudinal axis A of the article 1, which extends from the mouth end 5 to the opposing end 6 of the article 1. In the present embodiment, the at least one aerosol generating material 3 is generally arranged centrally in the article 1 with the wrappers arranged in layers concentrically about the at least one aerosol generating material 3, as will be described in more detail hereinafter. However, it will be appreciated that in alternative embodiments, the article 1 may have any other prismatic shape.

In the present embodiment, the first wrapper 8 circumscribes the whole length of the of the heating apparatus receiving region 7. That is, the first wrapper 8 extends from an upstream end 7a of the heating apparatus receiving region 7 to a downstream end 7b of the heating apparatus receiving region 7. The first wrapper 8 comprises an inner surface 9. The inner surface 9 faces into the heating apparatus receiving region 7. Therefore, the first wrapper 8 defines the upstream end 7a and forms the side wall defining the heating apparatus receiving region 7. The heating apparatus receiving region 7 may have a length in the range of about 10 mm to about 15 mm. In some embodiments, the heating apparatus receiving region 7 may have a length of about 12 mm.

In some embodiments, the first wrapper 8 may be formed from an aluminium foil. The aluminium foil may advantageously conduct heat from the heating apparatus 102 to the remainder of the article 1 when heating apparatus 102 is inserted into the heating apparatus receiving region 7. The aluminium foil may also advantageously prevent combustion of the article 1 during use. The first wrapper 8 may have a length in the range of about 15 mm to 30 mm. In some embodiments, the first wrapper 8 may have a length of about 25 mm. In alternative embodiments, the first wrapper 8 may be formed from any material that can conduct heat without burning/combusting and is flexible, for example, but not limited to, metal foils such as copper.

In some embodiments, the first wrapper 8 may comprise a third aerosol-generating material 9a located on its inner circumferential surface 9. The third aerosol-generating material 9a may cover substantially all of the inner circumferential surface 9 of the first wrapper 8. In other embodiments, the third aerosol-generating material 9a may cover only a portion of the inner circumferential surface 12 of the first wrapper 8. The third aerosol-generating material 9a may form a pattern on the inner circumferential surface 12 of the first wrapper 8. The third aerosol generating material may be an aerosol generating film. The aerosol generating film may comprise an amorphous solid material. The amorphous solid material may be non-fibrous.

As previously mentioned, the heating apparatus receiving region 7 is configured to receive a portion 102 of a heating apparatus 102, during use. In some embodiments, the heating apparatus receiving region 7 may be empty. That is, the space between the inner surface 9 of the first wrapper 8 may be void of any further material.

However, in the present embodiment, the heating apparatus receiving region 7 comprises a filler material 10. The filler material 10 may be non-combustible. Therefore, the filler material 10 can prevent the article 1 from combusting during use to maintain the generation of aerosol without combustion. The filler material 10 may be and inert up to in the range of about 600° C. to about 900° C. That is, the filler material may be formed from a material that does not thermally decompose or release toxicants upon heating.

The filler material 10 may be a compressible material. The filler material may have a honeycomb structure or a mesh-like structure. These structures may help the filler material to compress. These structures may also provide a plurality of air pathways through the filler material 10. Therefore, the filler material 10 can be compressed when a portion 102 of a heating apparatus 102 is pushed into the heating apparatus receiving region 7. The filler material 10 may be crimped and/or gathered strips of material. Furthermore, the filler material 10 may be a heat conducting material. The filler material 10 may have a thermal conductivity in the range of about 100 W/mK to about 300 W/mK at 20° C. and 1 bar. In some embodiments, the filler material 10 may have a thermal conductivity in the range of about 200 W/mK to about 250 W/mK at 20° C. and 1 bar. For example, aluminium has a thermal conductivity of about 239 W/mK at 20° C. and 1 bar.

In some embodiments, the filler material 10 may comprise fibre glass. In alternative embodiments, the filler material 10 may comprise gathered aluminium or an aluminium foil. In yet further embodiments, the filler material 10 may comprises at least one of, for example, but not limited to, a fibre glass, gathered aluminium, aluminium foil, or any other suitable material that has the properties outlined above.

In the present embodiment, the article 1 comprises a first aerosol generating material 11 and a second aerosol generating material 12. The first aerosol generating material 11 is located adjacent to the heating apparatus receiving region 7. The first aerosol generating material 11 comprises an upstream end 11a and a downstream end 11b. The upstream end 11a of the first aerosol generating material 11 is proximate the heating apparatus receiving region 7, more specifically, the downstream end 7b of the heating apparatus receiving region 7. The downstream end 11b of the first aerosol generating material 11 is distal to the heating apparatus receiving region 7, i.e. closer to the mouth end 5 of the article 1 than the upstream end 11a of the first aerosol generating material 16. The first aerosol generating material may be a non-fibrous material.

In the present embodiment, there is a gap 14 between the downstream end 7b of the heating apparatus receiving region 7 and the upstream end 11a of the first aerosol generating material 11. The gap 14 allows for movement of the filler material 10 in the direction of the mouth end 5 during insertion of the heating apparatus 102 of an aerosol provision device 100. The gap 14 may ensure that a heating apparatus 102 of an aerosol provision device 100 is at least partially received into the heating apparatus receiving region 7 due to movement of the filler material 14 towards the mouth end 5 of the article 1 irrespective of whether the filler material 14 is compressible.

In some embodiments, the filler material 14 may be moved towards the mouth end 5 before it compresses. In other embodiments, the filler material 14 may be moved towards the mouth end 5 only after it has been sufficiently compressed. In further alternative embodiments, the filler material 14 may not move at all and may only be compressed. In such embodiments, the article 1 may not comprise a gap 14 between the downstream end 7b of the heating apparatus receiving region 7 and the upstream end 11a of the first aerosol generating material 11.

The downstream end 7b of the heating apparatus receiving region 7 is defined by the first aerosol generating material 11, more specifically the upstream end 11a of the first aerosol generating material 11. In the present embodiment, the first wrapper 8 extends downstream of the downstream end 7b of the heating apparatus receiving region 7. The first wrapper 8 circumscribes at least a portion of the first aerosol generating material 11.

In the present embodiment, the first wrapper 8 circumscribes the full length of the first aerosol generating material 11. That is, the first wrapper 8 extends from the upstream end 11a of the first aerosol generating material 11 to the downstream end 11b of the first aerosol generating material 11. The first wrapper 8 surrounds the first aerosol generating material 11. Therefore, in the present embodiment as shown in FIG. 1, the first wrapper 8 extends from the upstream end 7a of the heating apparatus receiving region 7 to the downstream end 11b of the first aerosol generating material 11.

In the present embodiment, the first aerosol generating material 11 forms a core section 16 and is wrapped by a first overwrap 17. The core section 16 of first aerosol generating material 11 comprises an upstream end 16a and a downstream end 16b. The upstream end 16a is located proximate to the heating apparatus receiving region 7. The first overwrap 17 is wrapped around the core section 16 of first aerosol generating material 11. That is, the first overwrap 17 circumscribes the core section 16 of first aerosol generating material 11 and extends from the upstream end 16a of the core section 16 to the downstream end 16b of the core section 16. Therefore, the downstream ends 8b, 16b, 17b of the first wrapper 8, the core section 16 of first aerosol generating material 11, and the first overwrap 17 are all the same distance from the mouth end 5 of the article 1. It will be appreciated that in some embodiments, the overwrap 17 may be omitted.

In the present embodiment, the first aerosol generating material 11 comprises a plurality of beads 18. That is, the core section 16 of the first aerosol generating material 11 may be formed by a plurality of beads 18. The beads may be formed from, for example, but not limited to, milled tobacco or agglomerated tobacco, calcium carbonate, carboxymethyl cellulose, a humectant such as glycerol or propylene glycol, and water. The beads 18 are able to release more aerosol than cut filler due to their larger surface area. The beads 18 may also be denser than cut filler and thus able to store more aerosolisable material for aerosolising.

In an alternative embodiment, the first aerosol generating material 11 may comprise for example, but not limited to, an amorphous solid material. The amorphous solid material may be non-fibrous. Furthermore, the first overwrap 17 may be formed by a heat conductive material such as aluminium. In some embodiments, the first overwrap 17 may be formed from paper or a foil tube, for example, but not limited to, aluminium foil. However, in further alternative embodiments, the first overwrap 17 may be formed by, for example, but not limited to, bandcast reconstituted tobacco.

In the present embodiment, the first overwrap 17 is located between the core section 16 of first aerosol generating material 11 and the first wrapper 8. Thus, the diameter of the first aerosol generating material 11 is the same as the heating apparatus receiving region 7 and/or filler material 10. Both the heating apparatus receiving region 7 and the first aerosol generating material 11 are wrapped by the first wrapper 8.

In some embodiments, the length of the first aerosol generating material 11 may be in the range of about 10 mm to about 15 mm. Therefore, the length of the first overwrap 17 may be in the range of about 10 mm to 15 mm. In some embodiments, the length of the first aerosol generating material 11 may be about 13 mm. Therefore, the length of the first overwrap 17 may be about 13 mm. In some embodiments, the length of the core section 16 of first aerosol generating material 11 and the first overwrap 17 are the same.

As previously mentioned, the article 1 comprises a second aerosol generating material 12. The second aerosol generating material 12 comprises an upstream end 12a proximate to the heating apparatus receiving region 7 and a downstream end 12b that is closer to the mouth end 5 than the upstream end 12a of the second aerosol generating material 12. The second aerosol generating material 12 is located downstream of the first aerosol generating material 11. In the present embodiment, the second aerosol generating material 12 is located immediately downstream of the first aerosol generating material 11. That is, the upstream end 12a of the second aerosol generating material 12 is in contact with the downstream end 11b of the first aerosol generating material 11.

In the present embodiment, the second aerosol generating material 12 forms a core section 21 wrapped by a second overwrap 22. The core section 21 of second aerosol generating material 12 comprises an upstream end 21a and a downstream end 21b. The second overwrap 22 is wrapped around the core section 21 of second aerosol generating material 12. That is, the second overwrap 22 circumscribes the second aerosol generating material 12 and extends from the upstream end 21a of the second aerosol generating material 12 to the downstream end 21b of the second aerosol generating material 12.

The second aerosol generating material 12 is located coaxially with the first aerosol generating material 11. In the present embodiment, the diameter of the second aerosol generating material 12 is the same as the first aerosol generating material 11. In the present embodiment, the second overwrap 22 has a thickness equal to the combined thickness of the first wrapper 8 and the first overwrap 17.

In the present embodiment, the second aerosol generating material 12 comprises a tobacco rod 23. The tobacco rod 23 may be removed in some embodiments to reduce the mass of the article. The tobacco rod 23 may be formed from, for example, but not limited to, reconstituted tobacco, bandcast tobacco, cut rag tobacco. The second overwrap 22 may comprise a tobacco rod plug wrap formed from, for example, but not limited to, paper, aluminium foil, or any other suitable material used to wrap delivery systems.

In some embodiments, the length of the second aerosol generating material 12 may be in the range of about 30 mm to about 40 mm. Therefore, the length of the second overwrap 22 may be in the range of about 30 mm to 40 mm. In some embodiments, the length of the second aerosol generating material 12 may be about 37 mm. Therefore, the length of the second overwrap 22 may be about 37 mm. In some embodiments, the length of the second aerosol generating material 12 and the second overwrap 22 are the same.

The article 1 may further comprise a conductive element 25. The conductive element 25 may extend at least partially around the aerosol generating material 3. In the present embodiment, the conductive element 25 comprises a second wrapper 26, as shown in FIG. 1. The second wrapper 26 extends at least partially around the first wrapper 8 and at least partially around the second aerosol generating material 12. That is, the second wrapper 26 circumscribes at least a portion of the length of the first wrapper 8, and therefore the first aerosol generating material 11, and at least a portion of the length of the second aerosol generating material 12.

In the present embodiment, the second wrapper 26 extends from the heating apparatus receiving region 7 towards the mouth end 5 of the article 1. Therefore, the second wrapper 26 extends fully around the length of the first aerosol generating material 11 and partially around the second aerosol generating material 12. More specifically, the second wrapper 26 extends around the first wrapper 8 from the upstream end 8a of the first wrapper 8 beyond the downstream end 8b of the first wrapper 8, therefore around the first aerosol generating material 11, and around at least a part of the second overwrap 22 around the second aerosol generating material 12. The second wrapper 26 may have a length in the range of about 45 mm to about 50 mm. In the present embodiment, the second wrapper 26 has a length of about 48 mm.

The second wrapper 26 may be formed from an overwrap comprising a paper-foil laminate. The foil may comprise aluminium. The second wrapper 26 is configured to conduct heat received from the heating apparatus 102 that is located in the heating apparatus receiving region 7 during use, to the first and second aerosol generating materials 11, 12. The heat conducted along the second wrapper 26 helps to aerosolise the aerosolisable material in the aerosol generating materials 11, 12 and the gel substrate 8a when present.

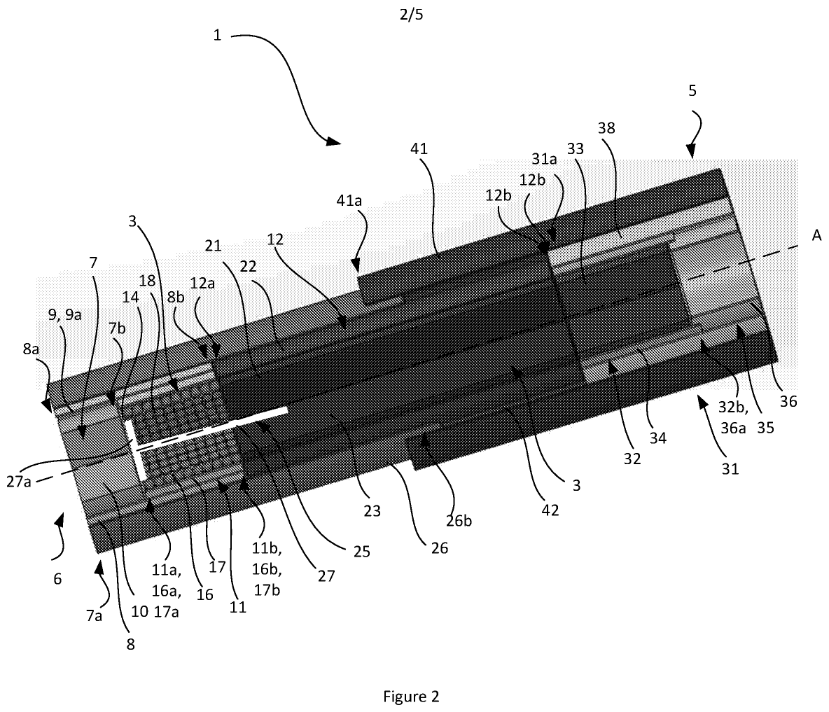

It will be appreciated that in alternative embodiments, the second wrapper 26 may be present but may not form the conductive element 25. In such embodiments, the conductive element 25 may extend at least partially through the aerosol generating material 3, as shown in FIG. 2.

For example, the conductive element 25 may comprise a rod 27. The rod 27 may extend from the upstream end of the first aerosol generating material 11 towards the mouth end 5 of the article 1. The rod 27 may extend through the length of the first aerosol generating material 11 and at least partially through the second aerosol generating material 12.

In some embodiments, the rod 27 may comprise an enlarged upstream portion 27a in the form of a disc. The enlarged upstream portion 27a is configured to absorb as much heat as possible from the heating apparatus 102 in the heating apparatus receiving region 7. The enlarged upstream portion 27a may comprise apertures (not shown) to allow the flow of air and/or aerosol through the conductive element 25.

It will be further appreciated that in some embodiments, the conductor may not be formed by the first wrapper 8 as described above. That is, the conductor may be formed by another component such as the conductive element 25 in the form of the second wrapper 26 or the rod 27. Specifically, the first wrapper 8 may still be present but the article 1 may be configured so that the conductor responsible for transferring and/or conducting heat from the heating apparatus receiving region to the aerosol generating material, during use, may be the second wrapper 26 or the rod 27.

Referring now to FIGS. 1 to FIG. 3, the article 1 may further comprise a filter portion 31. The filter portion 31 may be located at the downstream end 12b of the second aerosol generating material 12. The filter portion 31 may be located coaxially with the second aerosol generating material 12. An upstream end 31a of the filter portion 31 may contact the downstream end 12b of the second aerosol generating material 12.

In the present embodiment, the filter portion 31 comprises a solid filter portion 32. The solid filter portion 32 is configured to remove selected substances from the flow of generated aerosol and provide the required pressure drop through the article 1 to give the user a sensation similar to smoking a cigarette. The solid filter portion 32 may comprise a filter plug 33 and a filter plug wrap 34. The filter plug 33 comprises a filter plug material such as, for example, but not limited to, cellulose acetate, or paper. The filter plug 33 may have the same diameter as the second aerosol generating material 12.

The filter portion 31 of the article 1 may further comprise a hollow filter portion 35. The hollow filter portion 35 may be located downstream of the solid filter portion 31. The hollow filter portion 35 may be formed by a hollow tube 36. The hollow tube 36 may be formed from, for example, but not limited to, cellulose acetate, or paper.

In the present embodiment, an upstream end 36a of the hollow tube 36 is in contact with the downstream end 32b of the solid filter portion 32. A downstream end 36b of the hollow tube 36 forms the mouth end 5 of the article 1. In the present embodiment, the outer diameter of the hollow tube 36 of the hollow filter portion 35 is the same size as the outer diameter of the solid filter portion 32.

The filter portion 31 may further comprises a combining filter plug wrap 38. In the present embodiment, the combining filter plug wrap 38 circumscribes the length of both the solid filter portion 32 and the hollow filter portion 35. Therefore, the outer diameter of the combining filter plug wrap 38 is slightly larger than the outer diameter of the first wrapper 8 and the second aerosol generating material 12 or its overwrap 22 when present.

The filter plug 33 and filter plug wrap 34 may have a length of about 14 mm. The hollow filter portion 35 may have a length of about 7 mm and is configured to cool the flow of aerosol leaving the mouth end 5 of the article 1 to prevent the aerosol from injuring a user. The combining filter plug wrap 38 may have a length of about 21 mm to cover the length of the filter portions 32, 35.

The article 1 may further comprise a tipping wrapper 41. The tipping wrapper 41 is configured to join the filter portion 31 to the portion of the article 1 comprising the at least one aerosol generating material 3. The tipping wrapper 41 circumscribes the filter portion 31 and is attached to the outer surface of the combining filter plug wrap 38. The tipping wrapper 41 extends from the mouth end 5 of the article 1 towards the heating apparatus receiving region 7. In the present embodiment, the tipping wrapper 41 extends over at least a portion of the second aerosol generating material 12 and at least a portion of the second wrapper 26. An upstream end 41a of the tipping wrapper 41 is attached to a downstream end 26b of the second wrapper 26.

Due to the differing diameters of the filter portion 31 and the first and second aerosol generating materials 11, 12, the tipping wrapper 41 is spaced from the second aerosol generating material 12 by an insulating gap 42. The insulating gap 42 is configured to reduce the amount of heat transferred to the tipping wrapper 41 and therefore to reduce the amount of heat transferred to a user's lips during use.

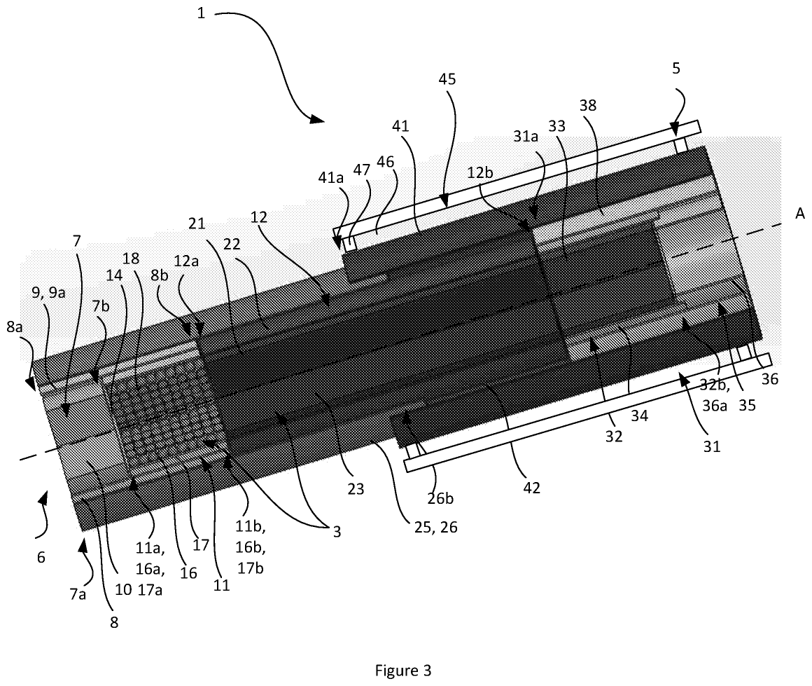

In some embodiments, the article 1 further comprises an outer wrapper 45, as shown in FIG. 3. The outer wrapper 45 is located around the tipping paper 41 of the article 1. The outer wrapper 45 is spaced from the tipping paper 41 of the article 1 to maintain an insulating space 46 from the rest of the article 1. The outer wrapper may comprise at least one projection 47 that is configured to contact the tipping paper 41 and maintain the insulating space 46. The outer wrapper 45 is configured to retain heat in the core of the article 1 whilst preventing excess heat being transferred to a user's lips during use.

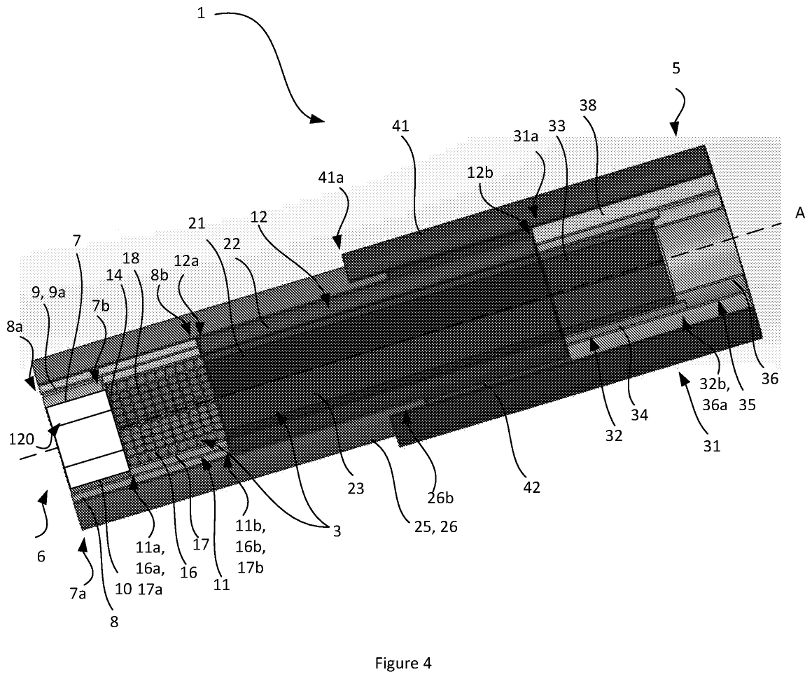

Referring to FIG. 4, it can be seen that in some embodiments the article 1 may further comprise a plug 120. The plug 120 may be at least partially received within the heating apparatus chamber 7. In some embodiments, the plug 120 may be at least partially received within the filler material 10 in the heating apparatus receiving region 7. The plug 120 is configured to conduct heat from a heating element of a non-combustible aerosol provision device 100 to the aerosol generating material 3, more specifically the first aerosol generating material 11. The plug 120 will be described in more detail hereinafter in relation to the aerosol provision device 100.

In the present embodiment, the plug 120 may contact the first wrapper 8 that is formed of aluminium foil. The aluminium foil first wrapper 8 is configured to conduct the heat from the plug 120 to the first aerosol generating material 11. The plug 120 may be formed from an inert material. The plug 120 is formed from a material that does not thermally decompose or release toxicants upon heating. The plug 120 may not thermally decompose or release toxicants up to a temperature of at least 700 degrees Celsius. The plug 120 may be formed from, for example, but not limited to, ceramic or glass or treated metals, i.e. with a electrically insulating coating. The plug 120 may comprise a central hole 111. The central hole 111 is configured to allow air to flow through the plug 120 from a device 100 into the article 1. The heated air that flows through the article 1 may aerosolise the aerosolisable material in the aerosol generating material 3 as it flows towards the mouth end 5 of the article 1.

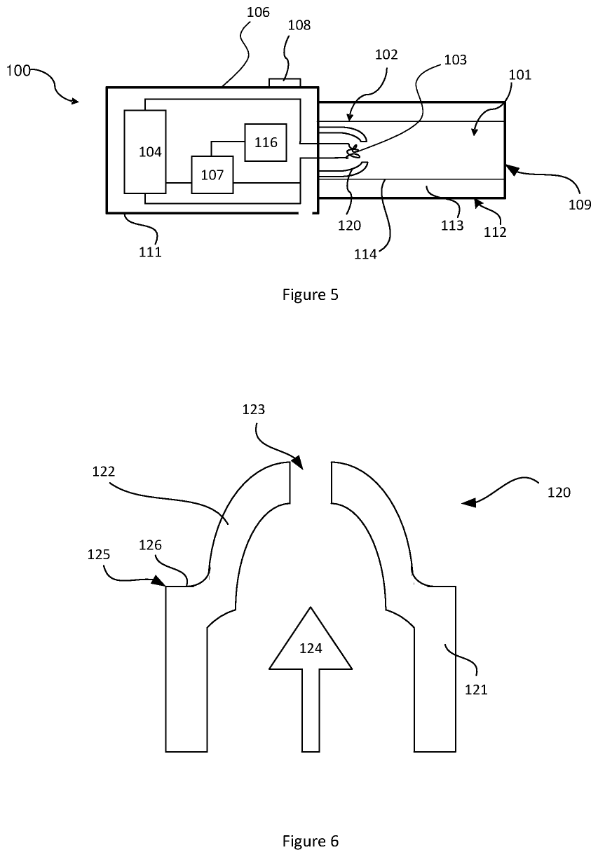

Referring now to FIG. 5, there is shown a non-combustible aerosol provision device 100. The non-combustible aerosol provision device comprises an article receiving section 101 and a heating apparatus 102. The heating apparatus 102 comprises a heating element 103 and a power source 104 configured to heat the heating element 103.

Furthermore, the heating apparatus 102 of the non-combustible aerosol provision device 100 further comprises a plug 120. The plug 120 surrounds the heating element 103. The heating element 103 is located at least partially in the article receiving section 101. The plug 120 is configured to be at least partially received within a heating apparatus receiving region 7, as described above in reference to FIG. 1, in an article 1 that is placed in the article receiving section 101 during use.

In FIG. 5, the components of an embodiment of a non-combustible aerosol provision device 100 are shown in a simplified manner. Particularly, the elements of the non-combustible aerosol provision device 100 are not drawn to scale in FIG. 5. Elements that are not relevant for the understanding of this embodiment have been omitted to simplify the Figure.

As shown in FIG. 5, the non-combustible aerosol provision device 100 comprises a housing 106 in which the article receiving section 101 is located. The housing 106 also houses the power source 104. The power source 104 may be an electrical energy supply, for example, but not limited to, a rechargeable lithium ion battery. A controller 107 is connected to the heating apparatus 102, power source 104 and a user interface 108, for example, but not limited to a button or display. The controller 107 controls the power supplied to the heating element 103 of the heating apparatus 102 in order to regulate its temperature.

The housing 106 of the non-combustible aerosol provision device 100 defines the article receiving section 101 in the form of a cavity, open at the proximal end (or mouth end) 109, for receiving an article 1, as described above, for consumption. The housing 106 comprises a main body 111 and a tubular portion 112. The tubular portion 112 comprises the cavity that forms the article receiving section 101 is located. The tubular portion 112 has a longitudinal axis A extending from the distal end of the tubular portion 112 adjacent to the main body 111 of the housing 106 to the proximal end 109 of the device.

The tubular portion 112 is formed by a tubular wall 113. In the present embodiment, the tubular wall 113 extends generally parallel to the longitudinal axis A of the article receiving section 101. The tubular wall 113 comprises an inner surface 114. The inner surface 114 of the tubular wall 113 defines the side walls of the article receiving section 101. The longitudinal axis of the tubular portion 112 and the longitudinal axis of the article receiving section 101 extend parallel to each other.

The plug 120 is located at the distal end of the article receiving section 101. That is, the plug 120 is spaced from the open end 109 of the article receiving section 101. In the present embodiment, the whole plug 120 is located in the article receiving section 101. Therefore, when an article 1 is inserted in the article receiving section 101, the whole plug 120 is able to be inserted into the heating apparatus receiving region 7 in the article. Thus, more heat can be transferred from the heating apparatus 102 to the article 1.

The plug 120 is configured to protect the heating element from contact with the article 1, during use. That is, the plug 120 may provide a physical barrier to prevent the heating element 103 contacting a part of the article 1, during use. For example, the plug 120 may prevent the filler material 10 in the heating apparatus receiving region 7 from contacting the heating apparatus 102.

When inserted into an article 1 comprising filler material 10 in the heating apparatus receiving region 7, the plug 120 may deform and/or compress and/or move the filler material 10 out of the way of the way of the heating element 103.

The plug 120 may extend substantially around the heating element 103. That is, the plug 120 substantially circumscribes the heating element 103. In the present embodiment, the plug extends fully around the heating element 103. That is, the plug 120 circumscribes the heating element 103 such that the plug 120 is located between the heating element 103 and tubular wall 113 in a direction perpendicular to the longitudinal axis A of the article receiving chamber 101.

Furthermore, the plug 120 may extend substantially over the heating element 103. That is, a portion of the plug 120 may extend at an angle to the longitudinal axis of the article receiving chamber 101 downstream of the heating element 103.

Referring to FIG. 6, the plug 120 may comprise a first portion 121 and a second portion 122. The first portion 121 is the distal portion located furthest from the mouth end 109 of the device 100 and the second portion 122 is the proximal portion of the plug 120. The first portion 121 of the plug 120 may be configured to extend substantially around the heating element 103. In the present embodiment, the first portion 121 is generally shaped like a hollow cylinder. The tubular element 121 is open at both ends.

The second portion 122 of the plug 120 may be configured to extend substantially over the heating element 103. In the present embodiment, the second portion 122 is generally shaped like a dome. However, in an alternative embodiment, the second portion 122 may be generally shaped like a truncated hollow cone, i.e. frusto-concial.

The plug 120 may comprise at least one aperture 103. The at least one aperture 123 is configured to provide a guide path 124 to allow air to flow from the non-combustible aerosol provision device 100 through the heating apparatus 102 and into an article 1 during use. The guide path 124 through the plug 120 extends generally parallel to the longitudinal axis A of the plug 120, which is parallel to the longitudinal axis of the article receiving section 101 and device 100.

In the present embodiment, the at least one aperture 123 is located in the second portion 122 of the plug 120. The guide path 124 extends from the distal open end of the first portion 121 of the plug 120 to the at least one aperture 123 in the second portion 122 of the plug 120.

In the present embodiment, the at least one aperture 123 comprises a single aperture located centrally in the dome shaped second portion 122 of the plug 120. This provides the advantage that the air flow is central through the device 100 and article 1 and provides an even and symmetrical air flow. Furthermore, the heat is located centrally in the system and so can flow and/or radiate outwards to heat the aerosol generating material 3 in the article 1.

However, it will be appreciated that in an alternative embodiment, the plug 120 may comprises a single off-centre aperture 123, a plurality of apertures 123 comprising a central aperture and further off-centre aperture, or a plurality of apertures 123 without a central aperture. It is thought that by providing a plurality of off-centre apertures 123, the heat from the heating apparatus 102 can be directed in multiple directions through the article 1 during use enabling a more even heat transfer through an article 1.

Furthermore, the use of a plurality of aperture 123 can reduce the size of each individual aperture for a given airflow through the plug 120, which reduces the likelihood of filler material 10 entering an aperture 123 and contacting the heating element 103.

The at least one aperture 123 may form at least one channel extending through the body of material forming the plug 120. The at least one channel may be configured to allow fluid to pass from outside of or from one side of the plug 120 through the channels and into an article 1 when an article 1 is received in the article receiving section 101.

In some embodiments, as shown in FIG. 6, the plug 120 may further comprise a shoulder portion 125. In the present embodiment, the shoulder portion 125 is formed by an end face 126 at the proximal end of the first portion 121 of the plug 120. To form the shoulder portion 125 from the first portion 121 of the plug 120, the diameter of the second portion 122 of the plug 120 has been reduced when viewing FIG. 6 compared to FIG. 5.

The shoulder portion 125 is configured to receive a wrapper 8, 26 of an article 1. That is, the shoulder portion 125 of the plug 120 is configured to have a wrapper 8, 26 of an article 1 abut against it, during use. Therefore, the shoulder portion 125 provides a stop that prevents an article 1 being inserted too far into the article receiving section 101, during use. Thus, in the embodiment, shown in FIG. 6, only the second portion 122 of the plug 120 is inserted into the heating apparatus receiving region 7 of the article 1.

In addition, the narrowing of cross-section area of the guide path 124 through the plug 120, i.e. cross-sectional area perpendicular to the longitudinal axis of the plug 120, may cause the velocity of the air flow though the plug 120 to increase. This may advantageously help heat transfer through the article 1 to aerosolise more of the aerosolisable material in a shorter space of time.

The plug 120 may be formed from a material that enables efficient heat transfer from the heating element 102 to the conductor. In the present embodiment, the conductor is the first wrapper 8. However, in other embodiments, the conductor may be the second wrapper 26 or the rod 27. By providing a plug 120 formed from a material that is efficient at transferring heat from the heating element 102 to the article 1 the amount of heat transferred to the article 1 can be increased, which can increase the amount of aerosol generated from the aerosol generating material 3 in a given time frame. The material that the plug 120 is formed from may have a thermal conductivity in the range of up to about 150 W/mK at 20 degrees Celsius and 1 bar, and may include material such as, for example, but not limited to silicon carbide and aluminium nitride.

In some embodiments, the plug 120 may have a high thermal capacity such that it is able to store heat and continue to heat the aerosol generating material even after the power to the heating element has been removed.

In some embodiments, the plug 120 may be dimensioned such that at least a part of the plug 120 abuts an inner surface of the heating apparatus receiving region 7, during use. This may advantageously help increase the efficiency of the heat transfer to the article 1 because the heat can then be transferred by conduction between the plug 120 and the wrapper 8 in addition to thermal convection by the heat air flow.

The plug 120 may be formed from a material that protects the rest of the device 100 from radiative heating. By providing a plug 120 formed from a material that protects the rest of the device 100 from radiative heating the device 100 can be protected from damage and parts of the device can be saved from overheating, which could cause harm or discomfort to the user.

The plug 120 may be formed from a material that does not thermally decompose at temperatures of up to 700 degrees Celsius. In some embodiments, the plug 120 may be formed from an inert material, at least inert up to 700 deg C.

The plug 120 may be formed from, for example, but not limited to, at least one of ceramic, fibre glass, or anodised or enamelled metal.

Referring back to FIG. 4, the heating element 103 is shown spaced from the plug 120. That is, there is an air gap between the heating element 103 and the plug 120. This provides passage for the air all around the heating element 103 and encourages heat transfer into the air flow through the plug 120 and into the article 1, during use.

However, it will be appreciated that in alternative embodiments, the heating element 103 may be in contact with the plug 120. In such an embodiment, heat can be conducted directly from the heating element 103 to the plug 120. Thus, the plug 120 can be heated directly by the heating element 103. This may help to provide a more uniform heat distribution in the air flow through the plug 120 and may help the plug to conduct heat into the article 1, especially in embodiments where the plug 120 is dimensioned to contact the wrapper 8 of the article 1, during use.

Furthermore, in some embodiments, the heating element 103 may be embedded in the plug 120. Thus, in such an embodiment, the heating element 103 directly heats up the plug 120. This, again, may help to provide a more uniform heat distribution in the air flow through the plug 120 and may help the plug to conduct heat into the article 1, especially in embodiments where the plug 120 is dimensioned to contact the wrapper 8 of the article 1, during use.

The heating element may be a resistive heating element. The resistive heating element may be formed by, for example, but not limited to, at least one of, a coil, a mesh, a ribbon, a matrix, or an inductive heater.

In some embodiments, the heating element 103 may be configured to be a sensor for determining when there is airflow through the device. The flow of air through the device 100 may cause a local temperature drop in the region of the heating element 103 due to cool air moving over the heating element 103. The change in temperature of the heating element 103 may result in a change of the resistance of the heating element 103, i.e. a change in current or voltage. This change is resistance may be monitored by the controller 107, which may associate a given value or given change in value with the presence of an air flow through the device due to a user drawing air through the device 100, and thus the controller 107 may heat up the heating element 103 in order to aerosolise the aerosolisable material in the aerosol generating material 3 of the article 1.

In an alternative embodiment, the device 100 may further comprise a pressure sensor and/or airflow sensor 116.

During use, a user may insert an article 1 into the article receiving section 101 of a non-combustible aerosol provision device. The user may insert the article 1 until the wrapper 8, 26 of the article 1 rests on the shoulder 125 of the plug 120 inside the article receiving section 101 or until the plug 120 is sufficiently located within the heating apparatus receiving region 7 of the article 1.

The user may then inhale on the mouth end 5 of the article 1, which will cause air to flow into the device 100 and through the main body 111 of the housing 106 into the tubular portion 112 via the plug 120. As air flow passes through the housing 106 is passes a pressure sensor or airflow sensor 116. The pressure sensor 116 sends information to the controller 107, which determines that the device 100 is being used and turns on power to the heating element 103. In an alternative embodiment, the heating element 103 itself may be used as the air flow sensor, as described above.

The heating element 103 heats the air flow which passes through the aperture 123 in the plug 120 into the article 1. The air flow flows through the first and second aerosol generating material 11, 12, and through the filter portion 31 to the user. On its path through the article, the hot air flow aerosolises aerosolisable material and delivers it to the user.

Simultaneously, heat from the heating element 103 is transferred by convection from the heat air to the first wrapper 8, and by conduction in embodiments where the plug 120 contacts the first wrapper 8. Heat is transferred along the first wrapper 8 to aerosolise aerosoliable material of the first aerosol generating material 11. Heat is also transferred from the first wrapper 8 to the second wrapper 26 and longitudinally toward the mouth end 5 of the article 1. The heat is the second wrapper 26 aerosolises aerosolisable material of the second aerosol generating material 12. Even if the heat conducted into the aerosol generating materials 11, 12 from the wrappers 8, 26 is not sufficient to aerosolise the aerosolisable material in the aerosol generating material 3 by itself, the rise in temperature of the aerosol generating materials 11, 12 allows for greater aerosolisation of the aerosol generating materials 11, 12 by the heated air flow though the article 1.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A non-combustible aerosol provision device comprising:
an article receiving section;
a heating apparatus, the heating apparatus comprising a heating element, a plug surrounding the heating element, and a power source configured to heat the heating element,
wherein the heating element is located at least partially in the article receiving section and the plug is configured to be at least partially received within a heating apparatus receiving region in an article placed in the article receiving section during use.

2. The non-combustible aerosol provision device according to claim 1, wherein the plug is configured to protect the heating element from contact with the article, during use.

3. The non-combustible aerosol provision device according to claim 2, wherein the plug extends substantially around the heating element.

4. The non-combustible aerosol provision device according to claim 3, wherein the plug comprises a first portion in the form of a hollow cylinder configured to surround the heating element.

5. The non-combustible aerosol provision device according to any one of claim 2 to claim 4, wherein the plug extends substantially over the heating element.

6. The non-combustible aerosol provision device according claim 5, wherein the plug extends substantially over the heating element such that the plug prevents direct contact between the heating element and an article when an article is received in the article receiving section.

7. The non-combustible aerosol-provision device according to claim 5 or claim 6, wherein the plug comprises a second portion in the form of a dome configured to extend over the proximal end of the heating element.

8. The non-combustible aerosol provision device according to any one of claim 1 to claim 7, wherein the plug comprises at least one aperture configured to provide a guide path to allow air flow from the device through the heating apparatus.

9. The non-combustible aerosol provision device according to claim 8, wherein the at least one aperture forms at least one channel extending through the body of material forming the plug, the at least one channel being configured to allows fluid to pass from one side of the plug through the channels and into an article when an article is received in the article receiving section.

10. The non-combustible aerosol provision device according to anyone of the preceding claims, wherein the plug is configured to provide both conduction and convection heating.

11. The non-combustible aerosol provision device according to any one of claim 8 to claim 10, wherein the plug comprises a centrally located aperture.

12. The non-combustible aerosol provision device according to any one of the preceding claims, wherein the plug is configured to electrically insulate the heating element from the article, during use.

13. The non-combustible aerosol provision device according to any one of the preceding claims, wherein the plug comprises a shoulder portion configured to receive a wrapper of an article.

14. The non-combustible aerosol provision device according to any one of the preceding claims, wherein the plug is formed from a material which enables efficient heat transfer from the heating element to a conductor of an article.

15. The non-combustible aerosol provision device according to any one of the preceding claims, wherein the plug is configured to abut an inner surface of a heating apparatus receiving chamber of an article.

16. The non-combustible aerosol provision device according to any one of the preceding claims, wherein the plug is formed from a material which protects the rest of the device from radiative heating.

17. The non-combustible aerosol provision device according to any one of the preceding claims, wherein the plug material is inert and/or does not thermally decompose at temperatures of up to 700 deg C.

18. The non-combustible aerosol provision device according to any one of the preceding claims, wherein the plug is formed from one of ceramic, fibre glass, or anodised or enamelled metal.

19. The non-combustible aerosol provision device according to any one of the preceding claims, wherein the heating element is spaced from the plug.

20. The non-combustible aerosol provision device according to any one of claim 1 to claim 18, wherein the heating element is in contact with the plug.

21. The non-combustible aerosol provision device according to any one of claim 1 to claim 18, wherein the heating element is embedded in the plug.

22. The non-combustible aerosol provision device according to any one of the preceding claims, wherein the heating element is a resistive heating element, for example, a coil, mesh, ribbon, matrix, or an inductive heater.

23. The non-combustible aerosol provision device according to any one of the preceding claims, wherein the heating element is configured to be a sensor for determining when there is airflow through the device.

24. The non-combustible aerosol provision device according to any one of the preceding claims, further comprising a pressure sensor or an airflow sensor configured to allow the heating apparatus to be activated via puff activation.

25. A system for aerosolising an aerosolisable material comprising:
an article comprising aerosol generating material; and
a non-combustible aerosol provision device according to any one of claim 1 to claim 24.

26. A use of the non-combustible aerosol provision device according to any one of claim 1 to claim 25 to generate aerosol from a consumable.
